(19) United States
(12) Patent Application Publication
(10) Pub. No.: US 2003/0161024 A1
(43) Pub. Date: Aug. 28, 2003

(54) Dual fibers coupled to an etalon

(76) Inventors: Qin Zhang, San Jose, CA (US); Hongwei Mao, Fremont, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/206,870

(22) Filed: Jul. 26, 2002

Related U.S. Application Data
(63) Continuation-in-part of application No. 10/087,087, filed on Feb. 27, 2002.
(63) Continuation-in-part of application No. 10/099,413, filed on Mar. 15, 2002.

(51) Int. Cl. G02F 1/03; G02F 1/07

(52) U.S. Cl. 359/260

(57) ABSTRACT

An etalon stage includes separate fibers that are used as input and output ports to an etalon. An optical system located between the fibers and the etalon couples light from the input fiber to the etalon to the output fiber.

### CROSS-REFERENCE TO RELATED APPLICATIONS

This application is a continuation-in-part of co-pending U.S. patent application Ser. No. 10/087,087, “Etalons with Variable Reflectivity,” by Qin Zhang, filed Feb. 27, 2002. This application is also a continuation-in-part of co-pending U.S. patent application Ser. No. 10/099,413, “Compensation of Chromatic Dispersion Using Cascaded Etalons of Variable Reflectivity,” by Qin Zhang and Jason T. Yang, filed Mar. 15, 2002.

The subject matter of all of the foregoing is incorporated herein by reference in its entirety.

### BACKGROUND OF THE INVENTION

1. Field of the Invention

This invention relates generally to an etalon stage that uses separate input and output fibers.

2. Description of the Related Art

As the result of recent advances in technology and an ever-increasing demand for communications bandwidth, there is increasing interest in optical communications systems, especially fiber optic communications systems. This is because optical fiber is a transmission medium that is well suited to meet the demand for bandwidth. Optical fiber has a bandwidth which is inherently broader than its electrical counterparts. At the same time, advances in technology have increased the performance, increased the reliability and reduced the cost of the components used in fiber optic systems. In addition, there is a growing installed base of laid fiber and infrastructure to support and service the fiber.

Despite this progress, optical communications is still in many respects very different from its electrical counterparts. Optical communications is inherently optical and relies on the manipulation of lightwave signals. As a result, many of the basic components used in fiber optic systems are unique to the optical domain: lasers, electro-optic and electro-absorptive modulators, photodetectors, lenses, beamsplitters, gratings, waveguides, couplers, and wavelength filters to name a few.

Etalons are one basic type of optical component. An etalon basically includes two or more parallel surfaces, each with a predetermined reflectivity, thus forming plano-plano cavities between the surfaces. Light that enters the etalon circulates within the etalon cavity . The resulting interference between multiply reflected waves causes interesting behavior. This behavior can potentially be used for a number of useful applications. For example, etalons have been suggested for use as wavelength filters. They potentially can also be used for dispersion compensation.

However, in order for an etalon to function correctly, light must enter and exit the etalon at a substantially normal angle. If the light enters the etalon at an angle that is not normal to the etalon's surface, then each round trip within the etalon will also result in a slight lateral displacement and, after a number of round trips, the cumulative lateral displacement may be so great that the multiple reflected waves do not interfere correctly with each other. This phenomenon is also known as walk-off. At the same time, to further simplify the optical design and reduce the number of components and cost, it is often desirable to use fibers directly as the input and output ports of the etalon.

FIG. 1 is a functional block diagram of a prior art etalon stage 12 using such an approach. The etalon stage 12 includes a circulator 36, a single fiber collimator 31 and an etalon 30. Light enters the stage 12 at input 52 and is directed by circulator 36 to the fiber collimator 31. The fiber collimator 31 includes a fiber pigtail and a collimating lens packaged together. The fiber collimator 31 directs the incoming light to the etalon 30. The fiber collimator 31 and etalon 30 (and also intervening optics, not shown) are aligned so that light from the fiber collimator 31 is normally incident upon etalon 30. The normal incidence ensures that the etalon 30 will function properly. It also ensures that the outgoing beam will couple back into the fiber collimator 31. Upon exiting the etalon 30, the light reenters the fiber collimator 31 to circulator 36. Circulator 36 directs the light to output 54. The circulator 36 is used to separate the incoming beam from the outgoing beam. However, this functionality comes at a price since circulators introduce at least a 0.7 dB loss through each pass of the device (a 1.4 dB total loss in this example). If a number of these stages are cascaded, the total optical loss due to the circulators alone quickly adds up.

Thus, there is a need for an etalon stage that uses optical fibers to couple to an etalon but which avoids the 1.4 dB losses that are inherent to circulators and similar devices.

### SUMMARY OF THE INVENTION

The present invention overcomes the limitations of the prior art by providing an etalon stage in which separate fibers are used as an input port and an output port to an etalon. An optical system located between the fibers and the etalon is used to couple between them. In some implementations, the optical system separates the fibers and the etalon to allow placement of additional devices in between them (e.g. a beam displacer).

In one implementation, the optical system directs light along a free space “forward” optical path from the input fiber to the etalon and along a free space “return” optical path from the etalon to the output fiber. The median plane is defined as the plane that is generally perpendicular to the plane defined by the fibers and optical paths, and that is generally located midway (relative to optical distances) between the fibers and to a lesser extent also midway between the optical paths. The optical paths are characterized by a central axis, which enters and exits the etalon at a substantially normal angle. In addition, the central axis crosses the median plane at least once and bends towards the median plane at least once within each optical path (i.e., in both the forward direction and the return direction).

In one example, the optical system includes a collimating lens (e.g., a GRIN lens) and optics located between the collimating lens and the etalon. The collimating lens is used to collimate light from the input fiber and to couple light back into the output fiber. In the forward direction, the collimating lens bends the central axis towards the median plane, the central axis crosses the median plane between the collimating lens and the optics, and the optics then bends the central axis back towards the median plane again. The central axis crosses the median plane at the etalon and the return optical path is a reciprocal mirror image of the forward optical path. Examples of suitable optics include wedges, prisms, mirrors, and devices based on total internal reflection. In some cases, the optics reduces the angle between the central axis and the median plane so that light enters the etalon at a near normal angle (e.g., within three degrees of normal in one application). The two fibers and collimating lens may be implemented as a dual fiber collimator.

In another example, the optical system includes two collimating lens (referred to as the forward collimating lens and the return collimating lens) and optics located between the collimating lenses and the etalon. The forward collimating lens is used to collimate light from the input fiber. The return collimating lens couples light back into the output fiber. In some implementations, the central axis enters and exits the etalon at a substantially normal angle, but does not cross the median plane between the fibers and the etalon.

In some applications, the etalon is a variable reflectivity etalon. The etalon has a transparent body having a first surface and a second surface that is substantially plane-parallel to the first surface. A second dielectric reflective coating is disposed upon the second surface. A first dielectric reflective coating is disposed upon the first surface. The first reflective coating has a reflectivity that varies according to location on the first surface. For example, in some implementations, the first reflective coating includes a top layer that has a physical thickness that varies according to location. Furthermore, the point of incidence of the central axis on the etalon is tunable in some implementations. For example, a beam displacer may be located between the fibers and the etalon, wherein the beam displacer translates the point of incidence to different locations on the etalon's first surface while maintaining substantially normal incidence of the central axis on the etalon's first surface.

### BRIEF DESCRIPTION OF THE DRAWING

The invention has other advantages and features which will be more readily apparent from the following detailed description of the invention and the appended claims, when taken in conjunction with the accompanying drawing, in which:

FIG. 1 (prior art) is a functional block diagram of an etalon stage using a circulator.

FIG. 2A is a functional block diagram of an etalon stage according to the invention.

FIG. 2B is a functional block diagram of another etalon stage according to the invention.

FIG. 3 is a side view of an etalon stage using refractive wedges.

FIG. 4 is a side view of an etalon stage using mirrors.

FIG. 5 is a side view of an etalon stage using total internal reflection with multiple bending.

FIG. 6 is a side view of an etalon stage with an asymmetric optical path.

FIG. 7 is a side view of an etalon stage with beam folding mirrors.

FIG. 8 is a block diagram of a dispersion compensation system according to the invention.

FIG. 9 is a perspective view of a variable reflectivity etalon.

FIG. 10A is a graph of group delay as a function of frequency for a single variable reflectivity etalon.

FIG. 10B is a graph of group delay as a function of wavelength illustrating the periodic nature of the group delay function.

FIG. 11 is a graph of group delay as a function of wavelength for a three-etalon dispersion compensation system.

FIG. 12 is a table listing parameters for realizing different values of chromatic dispersion.

FIG. 13 is a graph of dispersion tuning range in a channel pass band as a function of wavelength.

FIGS. 14A-14B are side views of variable reflectivity etalons having a top layer with continuously variable thickness.

FIG. 15 is a side view of a variable reflectivity etalon having a top layer with stepwise variable thickness.

FIG. 16A is a graph of reflectivity as a function of layer thickness.

FIG. 16B is a graph of phase shift and wavelength shift in spectral response as a function of layer thickness.

FIG. 17 is a side view of a variable reflectivity etalon with constant optical path length.

FIGS. 18A-18C are side views of a variable reflectivity etalon illustrating one method for manufacturing the etalon.

FIG. 19 is a top view of an etalon stage in which an optical beam is translated relative to a stationary variable reflectivity etalon.

FIG. 20 is a top view of an etalon stage in which a variable reflectivity etalon is translated relative to a stationary optical beam.

FIGS. 21A-21B are a perspective view and top view of an etalon stage that utilizes a rotatable beam displacer.

FIGS. 22A-22B are top views of an etalon stage that utilizes a moveable reflective beam displacer.

FIG. 23 is a top view of an etalon stage that utilizes a MEMS beam displacer.

### DESCRIPTION OF THE PREFERRED EMBODIMENTS

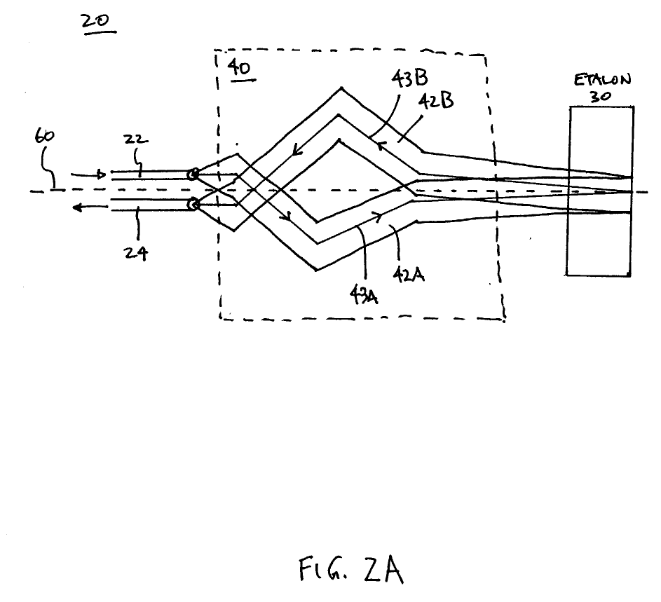

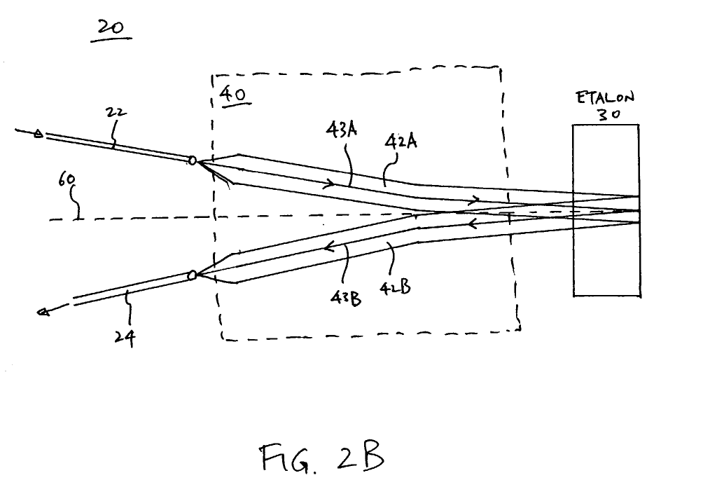

FIGS. 2A and 2B are functional block diagrams of etalon stages 20 according to the invention. In both of these examples, the etalon stage 20 includes an input fiber22, an output fiber 24, an etalon 30 and. an optical system 40 that is located between the fibers and the etalon.

The two fibers 22 and 24 serve as the optical input and output to the etalon stage 20. The fibers 22, 24 are held in position by conventional techniques: for example spacers, blocks with positioning grooves or capillaries. The optical system 40 directs light from the input fiber 22 to the etalon 30 and back to the output fiber 24. The optical path 42 is free space. For convenience, the term “forward optical path” 42A will be used to refer to the optical path from the input fiber 22 to the etalon 30 and the term “return optical path” 42B to refer to the path from the etalon 30 to the output fiber 24.

A median plane 60 is defined by the fibers 22, 24 and the optical path 42. The median plane 60 is generally perpendicular to the plane formed by the fibers and optical path, and generally located midway between the fibers 22, 24 and to a lesser extent also midway between the optical paths 42A, 42B. It may be geometrically non-planar if, for example, mirrors or other devices fold the optical path 42. The optical path 42 contains a central axis 43, which is the path traveled by the central ray from the input fiber 22 to the etalon 30 to the output fiber 24. The central axis 43 enters and exits the etalon 30 at a substantially normal angle.

In FIG. 2A, the optical system 40 is designed so that the central axis 43 crosses the median plane 60 at least once and also bends towards the median plane 60 at least once both in the forward direction (i.e., within the forward optical path 42A) and in the return direction (i.e., within the return optical path 42B). In contrast, in FIG. 2B, the central axes 43A, 43B do not cross the median plane 60 between the fibers 22, 24 and the etalon 30.

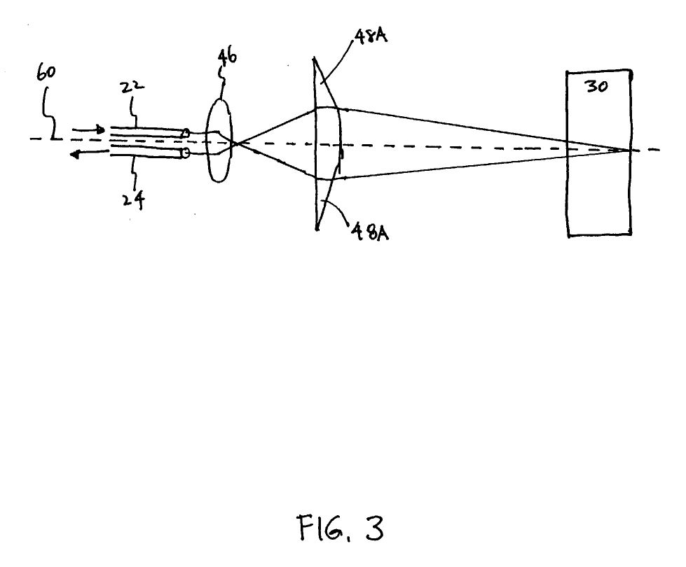

FIGS. 3-6 shows different implementations of the optical system 40 of FIG. 2A. In these examples, only the central axis of the optical path is shown for clarity. The optical system 40 includes a collimating lens 46 and additional optics 48 located between the collimating lens 46 and the etalon 30. In the forward direction, the collimating lens 46 collimates the light from the input fiber 22. In the return direction, the collimating lens 46 couples collimated light into the output fiber 24. In FIGS. 3-5, the optical path 42 is symmetric about the median plane 60. That is, the return optical path 42B is a reciprocal (since the light is propagating in the opposite direction) mirror image of the forward optical path 42A. This is not a requirement—FIG. 6 shows an example of an asymmetric optical path—but symmetry typically results in certain performance and manufacturing advantages.

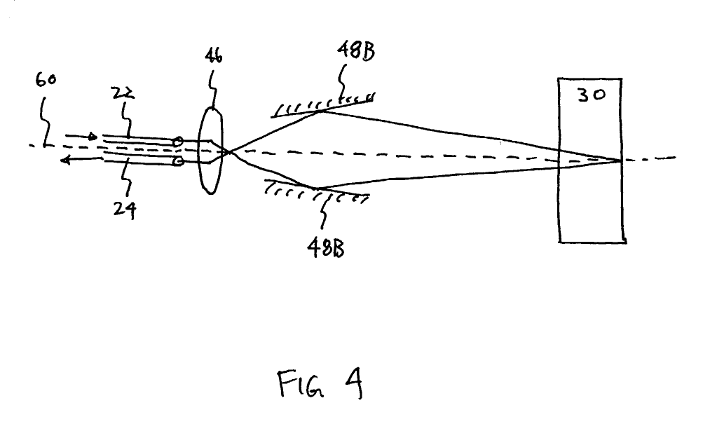

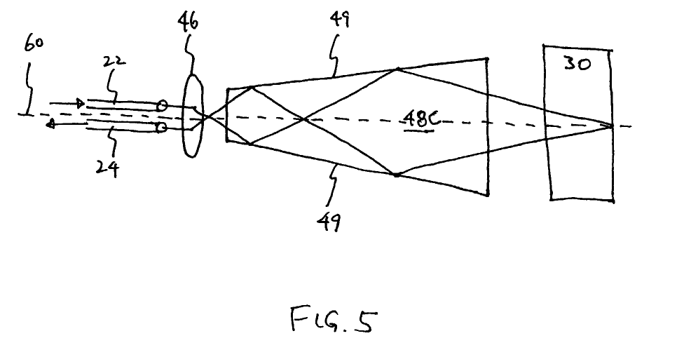

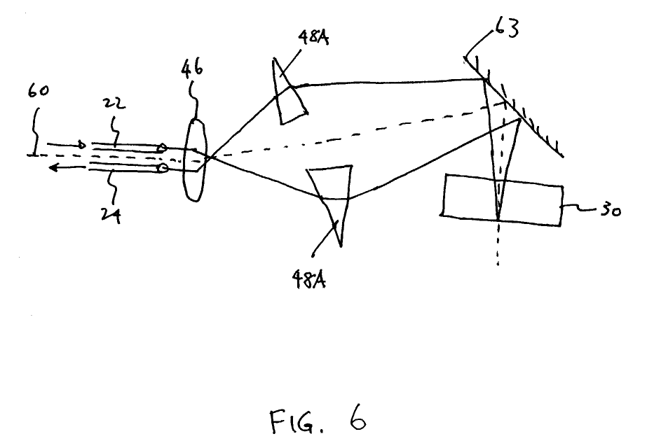

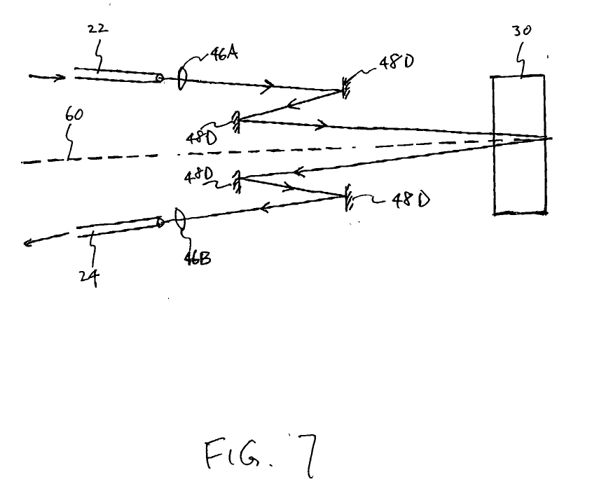

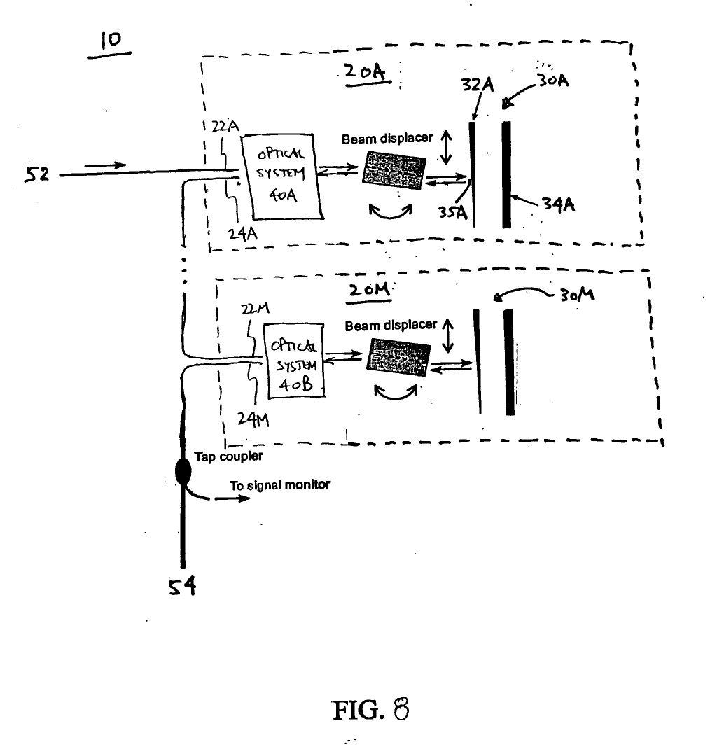

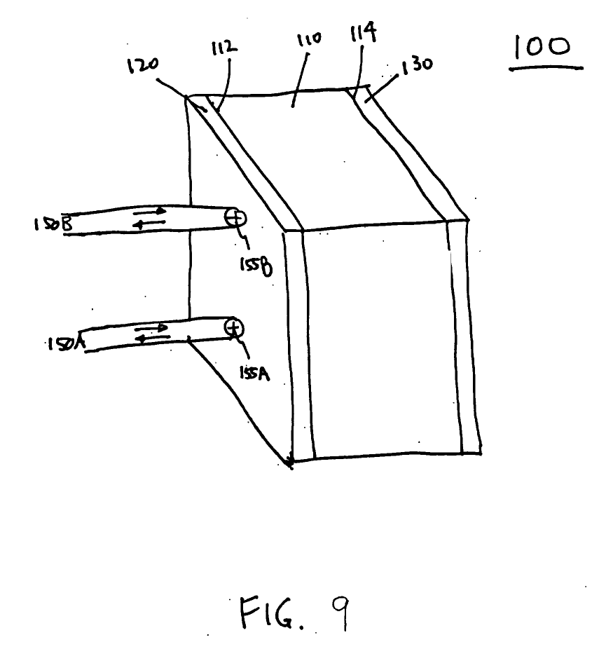

In FIGS. 3 and 4, the optical paths have the same general shape. The central axis 43 leaves the input fiber 22 parallel to the median plane 60 and the light is diverging. The collimating lens 46 collimates the light. It also bends the central axis 43 towards the median plane 60 and the central axis 43 crosses the median plane 60. The optics 48 bends the central axis 43 back towards the median plane 60. The central axis 43 travels through the etalon 30, where it crosses the median plane again, and begins its return trip to the output fiber 24. The return trip is the reverse of the forward trip. The central axis 43 is bent back towards the median plane 60 by the optics 48. It crosses the median plane and is bent to be parallel to the median plane by the collimating lens 46. The collimating lens 46 also focuses the light into the output fiber 24.

In one implementation, the two fibers 22, 24 and the collimating lens 46 are constructed as a single unit, typically referred to as a dual fiber collimator. Gradient index lenses (GRIN lenses) are often used as the collimating lens 46. In addition, it is desirable that the collimating lens 46 be designed so that the optical path 42 has its minimum waist at the etalon 30. Typically, this minimizes the spot sizes within the system and reduces diffraction losses.

The etalon 30 typically has a narrow acceptance angle. The central axis 43 must enter and exit at a substantially normal angle of incidence. For example, a typical tolerance for the dispersion compensation example described below is that the central axis 43 is within zero to three degrees of normal, although actual tolerances will depend on the application. If the central axis 43 leaves the collimating lens 46 at an angle that is greater than this tolerance, then the additional optics 48 reduces this angle to a value that is within tolerance.

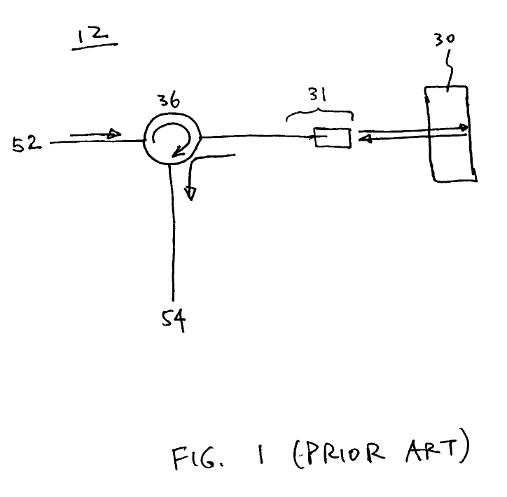

The etalon stage 20 has many advantages compared to other approaches. For example, the etalon stage 20 eliminates the circulator 36 used in the example of FIG. 1. This, in turn, eliminates the corresponding 1.4 dB losses and significantly reduces the cost of the etalon stage. In addition, the fiber assembly can be simplified since a conventional dual fiber collimator can be used. This is possible even if the angle of the central axis leaving the dual fiber collimator is too steep to be used directly with the etalon 30. The additional optics 48 reduces the angle to within the etalon's tolerances. It can also extend the separation between the fibers and the etalon to allow placement of additional devices in between them (e.g. a beam displacer).

In FIG. 3, the additional optics 48A are based on refractive wedges. In both the forward and the return direction, there is a wedge 48A with base oriented towards the median plane. That is, the wedges 48A are oriented to bend light towards the median plane. In FIG. 3, the two wedges 48A are shown as different parts of a single device. However, they can also be implemented as separate devices.

In FIG. 4, the additional optics 48B are based on mirrors. The central axis 43 is bent by reflection rather than refraction. In the geometry shown, if the central axis 43 makes approximately the same angle before reflection as it does after reflection, then the mirrors 48B will be facing and approximately parallel to the median plane 60. If they are not at exactly the same angle, then the mirrors 48B will be slightly tilted, as shown in FIG. 4.

In FIG. 5, the mirrors 48B of FIG. 4 are replaced by optics 48C that operate using total internal reflection (TIR). Basically, the central axis 43 enters a block of transparent material 48C, is totally internally reflected off of its faces 49 and then exits the block 48C. The TIR faces 49 take the place of the mirrors 48B. The design in FIG. 5 also illustrates multiple bendings. In the forward direction, the central axis 43 is bent two times by optics 48C and crosses the median plane 60 once between the bendings. Extending this concept, bending the central axis N times would result in N-1 crossings of the median plane. The multiple bending concepts can be implemented by many or all of the approaches discussed and is not limited to the TIR approach shown in FIG. 5.

As a final example, FIG. 6 illustrates a more complex, asymmetric optical path. This variation of the wedge approach of FIG. 3 is used to illustrate the following. First, the optical path is asymmetric. For example, the collimating lens may be off center and, as a result, bends one central axis more than the other. Alternately, the fibers 22 and 24 may be slightly misaligned, resulting in a similar skew. Or the etalon stage may be intentionally designed to be asymmetric. In addition, the two wedges 48A have different powers and are located in different positions. Thus, while the central axis 43 enters and exits the etalon 30 at near normal incidence, it is not symmetric relative to the median plane 60. A mirror 63 is also used to fold the optical path, perhaps to achieve a compact size. As a result of these asymmetries, the median plane 60 also is not strictly planar. FIG. 6 is used to illustrate some of the variations that are possible. Other variations will be apparent. For example, more complex prisms may be used in the optics 48, with the optical path making one or more internal reflections within the prism. As another variant, the optics 48 may bend the central axis a different number of times in the forward direction as in the reverse direction.

FIG. 7 shows an example implementation of the optical system 40 of FIG. 2B. In this example, the optical system 40 includes two collimating lenses 46A and 46B, one for each fiber. Collimating lens 46A (i.e., the forward collimating lens) collimates the light exiting the input fiber 22. The return collimating lens 46B couples collimated light back into the output fiber 24. Additional optics 48 (optional) direct the light from input fiber 22 to etalon 30 to output fiber 24.

In the example of FIG. 7, mirrors 48D fold the optical path in free space in order to reduce the overall size of the system. This approach simplifies the optics involved to bend the optical beams, resulting in a more stable system. Prisms, wedges, and other devices can also be used. In addition, many of the principles illustrated in the examples of FIGS. 3-6 are equally applicable to the basic design shown in FIG. 2B. For example, if the light leaves input fiber 22 at an angle that deviates too much from normal, optics 48 can be used to reduce this angle to within tolerance. As another example, the forward and return optical paths may or may not be mirror images of each other. As a final example, the fibers 22, 24 and collimating lenses 46A, 46B can be packaged together, for example as two separate single fiber collimators (as compared to the single dual fiber collimator of FIGS. 3-6).

The etalon 30 is depicted in FIGS. 1-7 as a simple etalon—a single block of material with two parallel faces that form a single resonant cavity. Other types of etalons may also be used, including compound or more complex etalons. For example, the etalon 30 may be constructed of multiple types of material, including air spaces. It may also have more than one resonant cavity. For example, the etalon may have a first face, first block of material, second face, second block of material and third face, thus forming two coupled resonant cavities. The etalon may also be tunable.

The etalon stage 20 may be used in a number of different applications. Some examples are wavelength filtering, gain flattening, wavelength locking and spectrum analysis. FIGS. 8-23 illustrate one example application- dispersion compensation using a variable reflectivity etalon.

FIG. 8 is a block diagram of a dispersion compensation system 10 using the etalon stages 20 according to the invention. The system includes at least one etalon stage 20A-20M, preferably two or more. Each etalon stage 20 includes an input fiber 22, an output fiber 24 and an etalon 30. Within the etalon stage 20, light travels along an optical path from the input fiber 22 through the etalon 30 to the output fiber 24.

The etalon stages 20 are cascaded to form a chain. In particular, the output fiber 24A of etalon stage 20A is coupled to the input fiber 22B of the next etalon stage 20B in the chain, and so on to the last etalon stage 20M. The input fiber 22A of the first etalon stage 20A serves as the input of the overall system 10 and the output fiber 24M of the last etalon stage 20M serves as the output of the overall system 10.

Thus, light propagates through the overall system 10 as follows. Light enters the system 10 at input 52 and is directed by fiber 22A to etalon stage 20A. Within the etalon stage 20A, the light is incident upon etalon 30A at point 35A. Upon exiting etalon stage 20A, the light enters output fiber 24A, which is connected to the input fiber 22B of the next stage 20B. The light propagates through the etalon stages 20 until it finally exits at output 54.

Each etalon 30 has a front dielectric reflective coating 32 and a back dielectric reflective coating 34. In at least one of the etalon stages 20, a point of incidence 35 of the optical path 42 on the front reflective coating 32 is tunable, meaning that the point of incidence 35 can be moved to different locations on the front reflective coating 32. The front reflective coating 32 of this particular etalon 30 has a reflectivity that varies according to location. Thus, the effective reflectivity of the etalon 30 can be adjusted by adjusting the point of incidence 35.

FIG. 9 is a perspective view of such a variable reflectivity etalon 100. The etalon 100 includes a transparent body 110 having a front surface 112 and a back surface 114. The front surface 112 and back surface 114 are substantially plane-parallel.

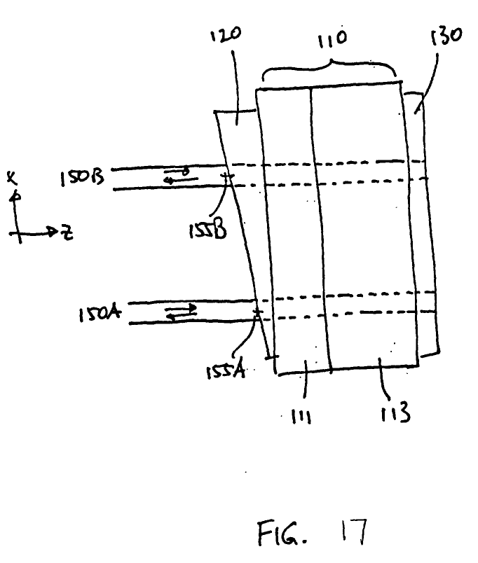

In one implementation, the transparent body 110 is made from a single block of material, as is suggested by FIG. 1. In another implementation, the transparent body 110 is made from blocks of different materials. For example, different materials may be bonded together to form a sandwich-type structure for the transparent body 110 (e.g., see FIG. 17). Alternately, some or all of the transparent body 110 may be formed by an air space or liquid crystals. In one implementation, in order from front surface 112 to back surface 114, the transparent body 110 consists of a first block of material, an air space, and a second block of material. The air space is maintained by spacers between the two blocks of material.

The front and back surfaces 112 and 114 are substantially plane-parallel in the sense that an optical beam 150 which is normally incident upon the front surface 112 also strikes the back surface 114 at an approximately normal angle of incidence. As will be seen in the examples below, it is not essential that the two surfaces 112 and 114 be exactly plane or exactly parallel. In typical cases, a parallelism of better than 0.5 arcsecond is sufficient although actual tolerances will vary by application. Furthermore, in certain cases, the optical path of a beam 150 through the etalon 100 may not be a straight line. For example, the optical beam 150 may be refracted through an angle at an internal interface in the etalon 100, or the optical path may be folded to form a more compact device by using mirrors, prisms or similar devices. In these cases, the front and back surfaces 112 and 114 may not be physically plane-parallel but they will still be optically plane-parallel. That is, the surfaces 112 and 114 would be physically plane-parallel if the optical path were unfolded into a straight line.

A back dielectric reflective coating 130 (labeled as back reflective coating 34 in FIG. 8) is disposed upon the back surface 114. The coating 130 has a reflectivity which is substantially 100%. A reflectivity somewhere in the range of 90-100% is typical, although the actual reflectivity will vary by application. If the reflectivity of back coating 130 is less than 100%, then light which is transmitted by the back coating 130 can be used to monitor the etalon 100. In applications where higher loss can be tolerated or the optical beam exits at least partially through the back surface 114, the reflectivity of back coating 130 can be significantly less than 100%. A front dielectric reflective coating 120 (labeled as coating 32 in FIG. 1) is disposed upon the front surface 112. The front reflective coating 120 has a reflectivity that varies according to location on the front surface 112.

The etalon 100 functions as follows. An optical beam 150 is incident upon the front surface 112 of the etalon 100 at a normal angle of incidence. The reflectivity of the etalon surfaces 112 and 114 results in multiple beams which interfere, thus producing etalon behavior. If the incoming optical beam is perfectly normal to the etalon's front surface 112 and the two surfaces 112 and 114 (and the coatings 120 and 130) are perfectly plane parallel, the output beam will exit the etalon 100 at the same location as the original point of incidence and will be collinear with the incoming beam 150 (but propagating in the opposite direction). The incoming and outgoing beams may be spatially separated at front surface 112 by introducing a slight tilt to the beam 150.

FIG. 9 shows two different positions for optical beam 150. In position A, the optical beam 150A strikes the front surface 112 at point of incidence 155A. In position B, the point of incidence is 155B. As will be shown below, different approaches can be used to tune the point of incidence to different locations on the etalon's front surface 112 while maintaining normal incidence of the optical beam. In etalon stage 20, the optical beam 150 arrives via an input fiber 22, propagates into the etalon 100 and exits via an output fiber 24. In one class of approaches, the fibers and/or the etalon 100 are moved in order to tune the point of incidence 155 to different locations. In another class of approaches, the fibers and etalon 100 are fixed relative to each other, but a separate beam displacer tunes the point of incidence 155 of the optical beam on the etalon 100.

At the two different points of incidence 155A and 155B, the front reflective coating 120 has a different reflectivity. Therefore, optical beam 150A is affected differently by etalon 100 than optical beam 150B. In effect, the reflectivity of the etalon can be adjusted by varying the point of incidence 155.

The dispersion D introduced by an etalon 100 can be calculated using conventional principles. In particular, the phase modulation φ introduced by etalon 100 is given by

$$φ = 2 {tan}^{- 1} ( \frac{r sin ω T}{1 + r cos ω T} ) \qquad ( 1 )$$

where r²=R is the reflectivity of the front coating 120, the back coating 130 is assumed to be 100% reflective, T is the round-trip delay induced by the etalon, and ω is the frequency of the optical beam 150. Specifically, T=OPL/c where c is the speed of light in vacuum and OPL is the total optical path length for one round trip through the etalon 100. If the one-way optical path through the etalon is a straight line of length L through material of refractive index n, then OPL=2nL. The group delay resulting from Eqn. (1) is

$$τ ( ω ) = \frac{ⅆ φ ( ω )}{ⅆ ω} = - 2 r T \frac{r + cos ω T}{1 + {r}^{2} + 2 r cos ω T} \qquad ( 2 )$$

The dispersion D of the etalon is then

$$D ( λ ) = \frac{ⅆ τ ( λ )}{ⅆ λ} \qquad ( 3 )$$

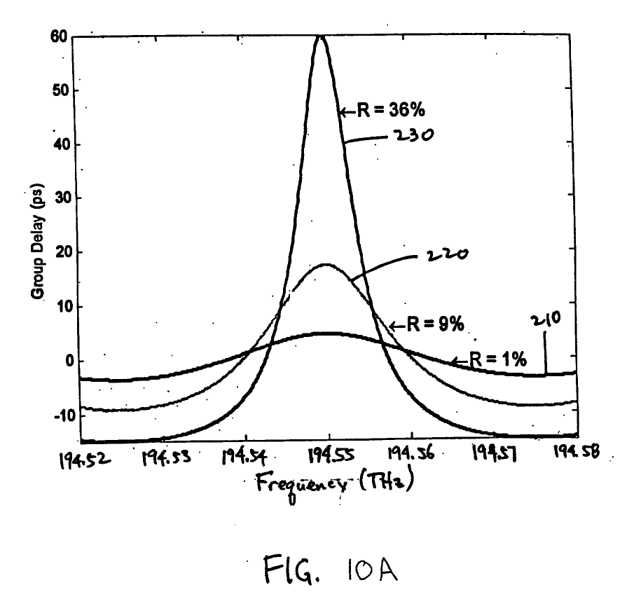

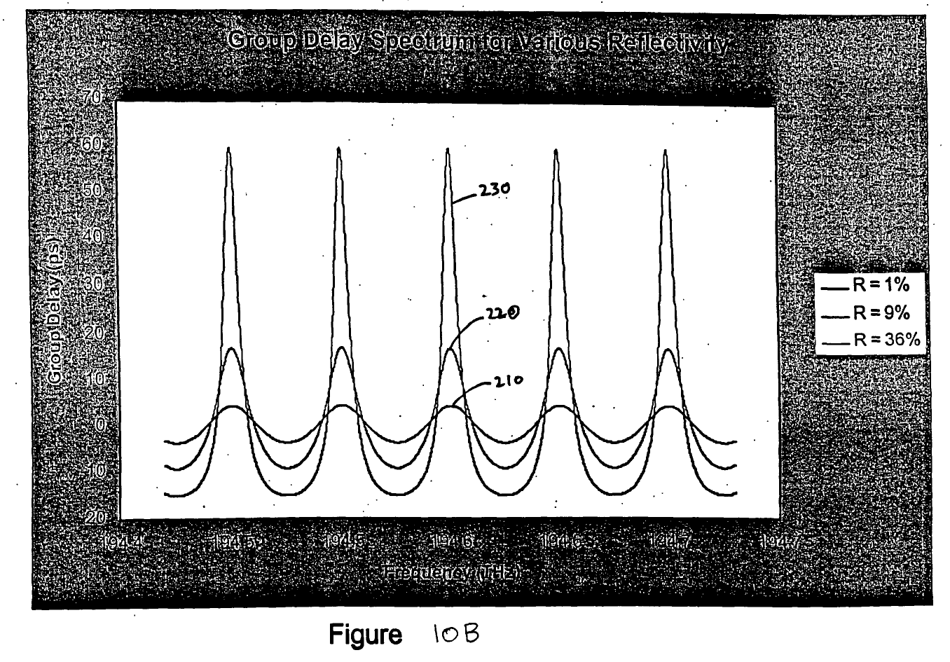

FIG. 10A is a graph of the group delay τ(ω) as a function of frequency f for three different values of the reflectivity R=r² where ω=2πf=2πc/λ where λ is the wavelength of the optical beam 150 and f the frequency. The curves 210, 220 and 230 correspond to reflectivity values R of 1%, 9% and 36%. The optical path length OPL is assumed to be constant for these curves. The different values of R are realized by varying the point of incidence 155 of the optical beam 150. For example, the point of incidence 155A in FIG. 9 might have a reflectivity R of 1%, resulting in dispersion D corresponding to the group delay curve 210. Similarly, point 155B might correspond to curve 220 and some other point of incidence might correspond to curve 230. Therefore, the group delay and the dispersion experienced by the optical beam 150 as it propagates through etalon 100 can be varied by varying the point of incidence 155. Note that in this application, the front and back reflective coatings 120 and 130 cannot be metallic since metallic coatings result in unpredictable phase modulation and the dispersion D depends on the phase modulation φ.

Furthermore, the group delay τ(ω) and dispersion D are periodic functions of the wavelength λ. The base period of these functions (also known as the free spectral range of the etalon) is set by the optical path length OPL. FIG. 10B is a graph of the group delay over a broader range of wavelengths (as compared to the graphs in FIG. 10A), illustrating the periodic nature of the function. In general, there is a single maximum and minimum for the group delay function in each period. Both the location of the maxima (or minima) and the free spectral range can be adjusted by changing the OPL. The location of the maxima and minima are sensitive to changes in the phase of the OPL. Significantly changing the free spectral range requires much larger changes in the value of OPL.

The design and selection of materials for etalon 100 (and the rest of the etalon stage 20, both for this particular application as well as other applications) depends on the wavelength λ of the optical beam 150, as well as considerations such as the end application, manufacturability, reliability and cost. Current fiber optic communications systems typically use wavelengths in either the 1.3 μm or 1.55 μm ranges and etalons intended for these systems would use corresponding materials. Etalons are useful in many other applications, including in the visible and near infrared regions, so the invention is not limited to the wavelength regions given above. Obviously, terms such as “optical,” “light,” and “transparent body 110” are relative to the wavelength of interest.

In one example, the etalon 100 is designed for use in the 1.55 μm wavelength range. The incoming optical beam 150 has a center wavelength (or multiple center wavelengths if the optical beam is wavelength division multiplexed) which is consistent with the ITU grid, as defined in the ITU standards.

The body 110 is a single block of optical purity glass, for example fused silica or BK7 glass. The length of body 110 is selected so that the free spectral range of the etalon 100 is matched to the basic periodicity of the ITU grid. For example, the ITU grid defines wave bands which are spaced at 100 GHz intervals. In one application, a fiber optic system implements one data channel per wave band and the free spectral range of the etalon 100 is 100 GHz, thus matching the ITU grid and the spacing of the data channels. In another application, two data channels are implemented in each wave band. The spacing between data channels is then 50 GHz, or half the band to band spacing on the ITU grid. The etalon 100 is designed to have a free spectral range of 50 GHz, thus matching the spacing of the data channels. The etalon can be designed to have a free spectral range that matches other periodicities, including those based on standards other than the ITU standards or those which are intentionally different than the ITU standards. For example, the etalon 100 may be intended for an application consistent with the ITU grid but the free spectral range of the etalon 100 may be different than the ITU periodicity in order to introduce variation in the etalon response from one band to the next. The front and back surfaces 112 and 114 are plane-parallel to within 0.5 arc seconds, typically. The back reflective coating 130 is a Bragg reflector with enough layers to achieve a reflectivity of over 99%

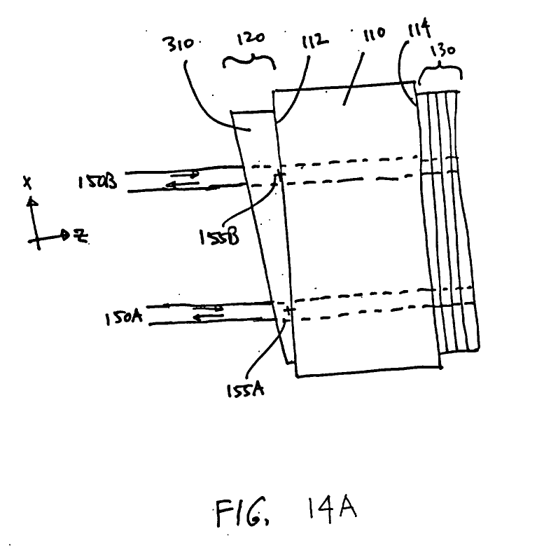

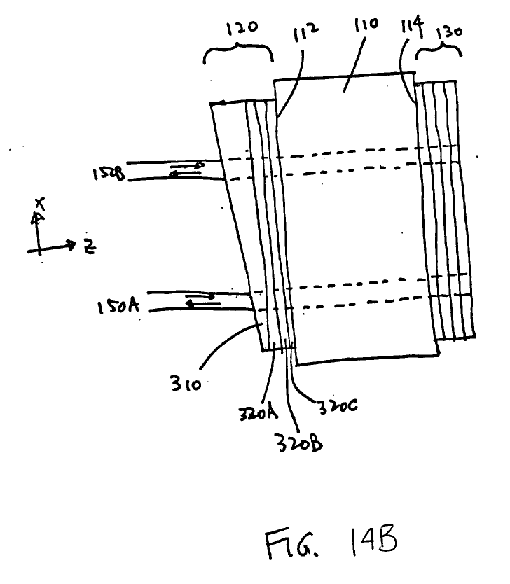

The front reflective coating 120 is a stack containing one or more layers of materials, as shown in the designs of FIGS. 14A and 14B. The detailed structure of the layers determines the range of reflectivities achievable by the front reflective coating 120 and depends on the application. In one embodiment, the front reflective coating 120 contains a single layer 310, as shown in FIG. 14A. The single layer 310 is Ta₂O₅ and has a thickness variation of a quarter wave of optical thickness. In other words, the thickest portion of the layer 310 is a quarter wave thicker than the thinnest portion. The corresponding reflectivity varies monotonically over a range from 4%-25%. If the thickness variation stays within a quarter wave (i.e., from zero to a quarter wave, or from a quarter wave to a half wave) then the reflectivity will be a monotonic function of thickness.

In another embodiment, the front reflective coating 120 is a stack of three layers, following the design of FIG. 14B (although the specific example in FIG. 14B shows four layers). Working away from the etalon body, the first two layers are quarter wave layers of Y₂O₃ and SiO₂, respectively, having refractive indices of 1.75 and 1.44. The top layer is Ta₂O₅, with a refractive index of 2.07. The thickness of the top layer varies from zero to a quarter wave. The resulting reflectivity of the front reflective coating varies over a range from 0%-40%.

Typically, by varying the thickness of top layer 310, a reflectivity variation of 40%-50% can be achieved. This variation can be translated to different offsets (e.g., to a range of 10%-60%, or 20%-70%, etc. for a variation 50%) by varying the number and materials of the layers 320 under the top layer 310. Typically, in the design of FIG. 14B, only the top layer 310 varies in thickness and the remaining layers 320 are an integer number of quarter waves in thickness. The underlying layers 320 typically are not exposed. Materials which are suitable for the Bragg reflector 130 and/or the stack of the front reflective coating 120 include Ta₂O₅, TiO₂, SiO₂, SiO, Pr₂O₃, Y₂O₃, and HfO₂.

Referring to FIG. 8, each etalon stage 20 introduces a certain group delay τ(ω) and corresponding dispersion D(λ). These quantities are additive. The cumulative group delay produced by all of the stages 20 is the sum of the group delays produced by each etalon stage 20. Similarly, the cumulative group delay produced by all of the stages 20 is the sum of the group delay produced by each etalon stage 20. By appropriately selecting the group delay introduced by each stage 20, a substantially linear group delay curve (or a substantially constant dispersion) can be achieved for the overall system over a certain operating bandwidth.

More specifically, suppose that there are a total of m etalon stages, as shown in FIG. 8. Let ω=2πc/λ=2πf, , where λ is the wavelength in vacuum and f is the frequency. Each individual stage i is characterized by a reflective coefficient rᵢ and round-trip delay Tᵢ=2(nᵢLᵢ+δᵢ)/c, where nᵢ and Lᵢ are the refractive index and nominal physical length of the body of the etalon (which is assumed to be constructed of a single material in this example) and δᵢ is a variable tuning factor. Eqn. (2) can be expressed for the i-th stage as

$${τ}_{i} ( λ ) = - ( \frac{4 {r}_{i} ( {n}_{i} {L}_{i} + {δ}_{i} )}{c} ) \frac{{r}_{i} + cos ( \frac{4 π ( {n}_{i} {L}_{i} + {δ}_{i} )}{λ} )}{1 + {r}_{i}^{2} + 2 {r}_{i} cos ( \frac{4 π ( {n}_{i} {L}_{i} + {δ}_{i} )}{λ} )} , i = 1 , 2 , … m \qquad ( 4 )$$

As shown in Eqn. (4), the group delay τᵢ is affected by both the reflective coefficient rᵢ m and the optical path length (nᵢLᵢ+δᵢ). It is possible to obtain a quasi-linear group delay by superimposing multiple group delay curves with proper phase matching conditions. To illustrate the concept of employing multiple stages to achieve a tunable quasi-linear group delay, the following example uses a three-stage configuration following the architecture in FIG. 8 (with M=m=3). The same idea can be extended to more or fewer stages in a straightforward manner. Increasing the number of stages reduces group delay ripple but at a cost of higher insertion loss and higher material cost. With enough stages, operating bandwidths which exceed 50% of the free spectral range of the etalons are possible.

The total group delay τ_{T}(λ) for an m-stage configuration can be expressed as

$${τ}_{T} ( λ ) = {\sum }_{i = 1}^{m} {τ}_{i} ( λ ) \qquad ( 5 )$$

Hence, the dispersion D of the multi-stage system is related to the total group delay τ_{T}(λ) by

$$D ( λ ) = \frac{ⅆ {τ}_{T} ( λ )}{ⅆ λ} \qquad ( 6 )$$

Generally, better performance can be achieved by adding more degrees of freedom. Better performance typically means larger dispersion tuning range, less residual dispersion and/or ripple (i.e., better dispersion compensation) and/or a wider operating bandwidth. More degrees of freedom typically means more stages 20, more variability in the reflectivity R and/or more variability in the optical path length OPL. Furthermore, with enough variability, a system 10 can be tuned to compensate for different amounts of chromatic dispersion.

The tunability can also compensate for manufacturing variability. For example, consider a situation in which the target reflectivity for a stage is 15%±0.01%. One approach would be to manufacture a constant-reflectivity etalon with a reflectivity of between 14.99 and 15.01%. An alternate approach would be to manufacture a variable reflectivity etalon which is tunable to15% reflectivity. For example, if the etalon nominally could be tuned over a range of 1%-40%, then even a manufacturing tolerance of ±1% (as opposed to ±0.01%) would result in an etalon which could reach the required 15% reflectivity.

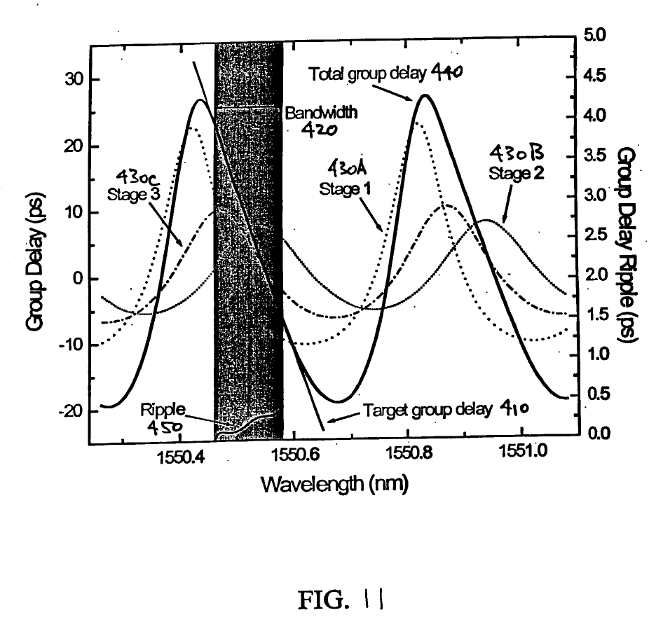

FIGS. 11-13 illustrate the operation of an example system 10 which contains three etalon stages 20, each of which is tunable in reflectivity R and OPL. The reflectivity R is adjusted by tuning the point of incidence 35 of the optical path on the etalon. The phase of the optical path length OPL is adjusted by tuning the temperature of the etalon 20. For convenience, the optical path length will be expressed as OPL =2(n L+δ), where n and L are the refractive index and nominal physical length of the body of the etalon (which is assumed to be constructed of a single material in this example), and δ a variable tuning factor. More stages typically will result in better dispersion compensation (i.e., less residual dispersion) but at the expense of higher attenuation and cost.

FIG. 11 is a graph of group delay as a function of wavelength for the three-etalon dispersion compensation system. The target group delay for the system is curve 410 over the operating bandwidth 420. Curves 430A, 430B and 430C show the group delay for each of the three stages and curve 440 is the total group delay for the system. Curve 450 shows the residual ripple. Note that each stage is tuned to a different reflectivity R (as evidenced by the different values for the peaks of the individual group delays 430) and to a different optical path length OPL (as evidenced by the different wavelengths at which the individual peaks occur). In fact, by tuning the stages to different values of reflectivity R and optical path length OPL, not only can the system compensate for a specific amount of chromatic dispersion, it can also be tuned to compensate for different amounts of chromatic dispersion.

In addition, since the group delays and dispersions are periodic, the system can compensate for chromatic dispersion on a per-channel or multi-channel basis. In other words, if the dispersion compensation system is used in an application with a predefined and periodic spacing of wavelength bands (e.g., the 50 GHz or 100 GHz spacing of the ITU grid), then the etalons can be designed to have a free spectral range that is approximately equal to the periodic spacing. In this way, the dispersion compensation system can be used over multiple wavelength bands. For example, the system may be designed to cover all of the wavelength bands in one of the commonly used communications bands: the C-band (1528-1565 nm), the L-band (1565-1610 nm) or the S-band (1420-1510 nm).

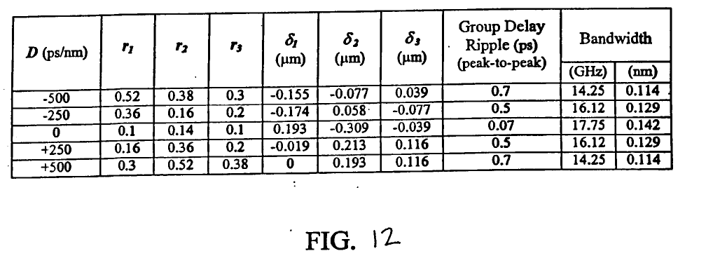

FIG. 12 is a table listing specific parameters for realizing different values of chromatic dispersion. The column D is the target dispersion. The six columns rᵢ and δᵢ are the values of reflective coefficient r (recall, reflectivity R=r²) and OPL tuning factor δ for each of the three stages i. Group Delay Ripple is the peak to peak deviation between the target group delay and the actual group delay realized. The curves in FIG. 11 correspond to the row for D=−250 ps/nm.

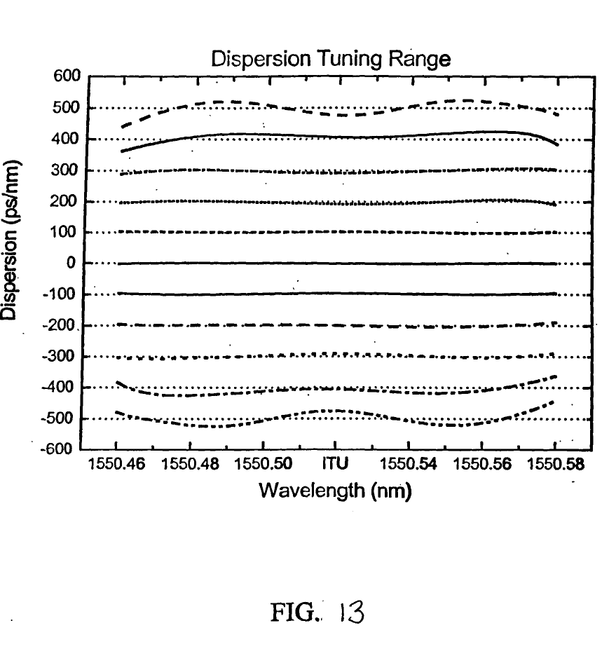

FIG. 13 illustrates the flexibility of this system as it is tuned to dispersion values ranging from −500 to +500 ps/nm. Each curve is generated by tuning the reflectivities and OPL tuning factors to different values. In other words, all of the curves shown in FIG. 13 are generated by a single physical system that is tuned to compensate for different values of dispersion. Note that the system can achieve zero dispersion with low ripple. The curves shown in FIG. 13 are merely examples. The system can be tuned to achieve dispersion values other than those shown, including dispersions with magnitude greater than 500 ps/nm.

In order to realize a specific dispersion, the system is tuned to specific values of reflective coefficient r and OPL tuning factor δ. These target values can be determined for each value of dispersion using standard optimization techniques. To a first order, the optimization problem can be described as, for a given operating bandwidth and a given target dispersion D, find the set of parameters (rᵢ, δᵢ) which minimizes some error metric between the actual dispersion realized and the target dispersion or, equivalently, between the actual group delay realized and the target group delay. For constant dispersion, the target group delay will be a linear function of wavelength. Examples of error metrics include the peak-to-peak deviation, maximum deviation, mean squared deviation, and root mean squared deviation. Examples of optimization techniques include the multidimensional downhill simplex method and exhaustive search. Exhaustive search is feasible since the degrees of freedom (rᵢ, δᵢ) typically have a limited range.

There can be multiple solutions for a given value of dispersion and factors in addition to the error metric typically are used to select a solution. For example, one such factor is the sensitivity of the solution to fluctuations in the parameters. Less sensitive solutions are usually preferred. Another factor is the manufacturability or practicality of the solution.

The solutions (rᵢ, δᵢ) for different dispersion values and/or operating bandwidths typically are calculated in advance. They can then be stored and recalled when required. In one embodiment, system 10 includes a lookup table that tabulates the parameters (rᵢ, δᵢ) as a function of dispersion and/or bandwidth. When a specific dispersion compensation is required, the corresponding parameters (rᵢ, δᵢ) are retrieved from the lookup table and the stages are tuned accordingly.

In order to tune the stages, a conversion from the parameters (rᵢ, δᵢ) to some other parameter is typically required. In the example three-stage system described above, the reflective coefficient is converted to a corresponding physical position and OPL tuning factor is converted to a corresponding temperature. There are many ways to achieve this. In one approach, each stage is calibrated and the calibration is then used to convert between (r,δ) and (x, T).

FIGS. 14-18 illustrate various manners in which the reflectivity can vary over the front surface 112 of a variable reflectivity etalon. In FIG. 14A, the front reflective coating 120 includes a top layer 310 of material. The physical thickness of the top layer 310 varies according to location on the front surface 112. In one implementation, the top layer 310 has a constant refractive index and the optical thickness, which is the product of the refractive index and the physical thickness, varies over a range between zero and a quarter wave. In the case where the optical thickness of top layer 310 varies from zero to a quarter wave, the reflectivity will vary from minimum at zero thickness to maximum reflectivity at quarter wave thickness. More generally, the thickness varies over a quarter wave (i.e., from zero to a quarter wave, or from a quarter wave to a half wave, or from a half wave to three quarters wave, etc.), resulting in a monotonic variation of reflectivity with thickness.

In the example of FIG. 14A, the thickness of top layer 310 changes monotonically with the linear coordinate x and does not vary in the y direction (i.e., into or out of the paper). If the optical thickness remains within a quarter wave range, the reflectivity of the front reflective coating 120 will also vary monotonically with x but will be independent of y. The dispersion D will also vary with x and not with y.

The front reflective coating 120 is not restricted to a single layer design. FIG. 14B shows a front reflective coating 120 with multiple layers. In this example, additional layers of material 320A-320C are disposed between the top layer 310 and the front surface 112. In one implementation, these layers 320 are constant refractive index and constant physical thickness. For example, they can be quarter wave layers (or integer multiples of quarter waves). The top layer 310 has a variable physical thickness, as in FIG. 14A. In alternate embodiments, some or all of the intermediate layers 320 may also vary in thickness.

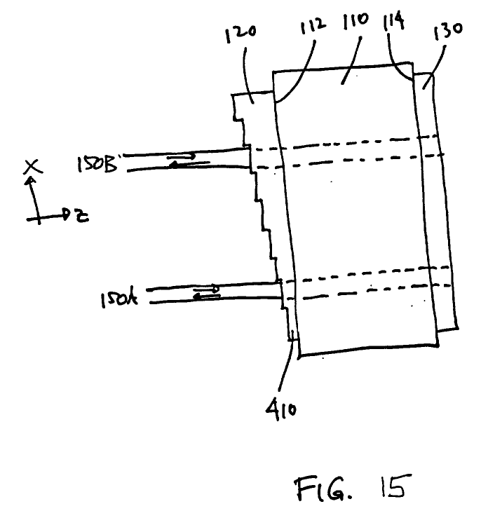

In the examples of FIGS. 14A and 14B, the reflectivity was a continuous function of location on the front surface. In both examples, the thickness of top layer 310 varied continuously with the linear coordinate x. In FIG. 15, the front reflective coating 120 includes a single layer 410 of material that varies in physical thickness in a stepwise fashion. That is, layer 410 has a constant thickness over some finite region, a different constant thickness over a second region, etc. In FIG. 15, these regions are rectangular in shape, with a finite extent in x but running the length of the etalon in y. However, they can be other shapes. For example, hexagonally-shaped regions are well matched in shape to circular beams and can be close packed to yield many different regions over a finite area.

Other variations of thickness as a function of position are possible. In this class of variable reflectivity etalons, the reflectivity of front reflective coating 120 is generally determined by the thickness of the coating (or of specific layers within the coating). Therefore, different reflectivity functions may be realized by implementing the corresponding thickness function. For example, reflectivity can be made a linear function of coordinate x by implementing the corresponding thickness variation in the x direction. The required thickness at each coordinate x can be determined since the relationship between thickness and reflectivity is known, for example by using conventional thin film design tools. The reflectivity and/or thickness can also vary according to other coordinates, including y, the polar coordinates r and θ, or as a two-dimensional function of coordinates.

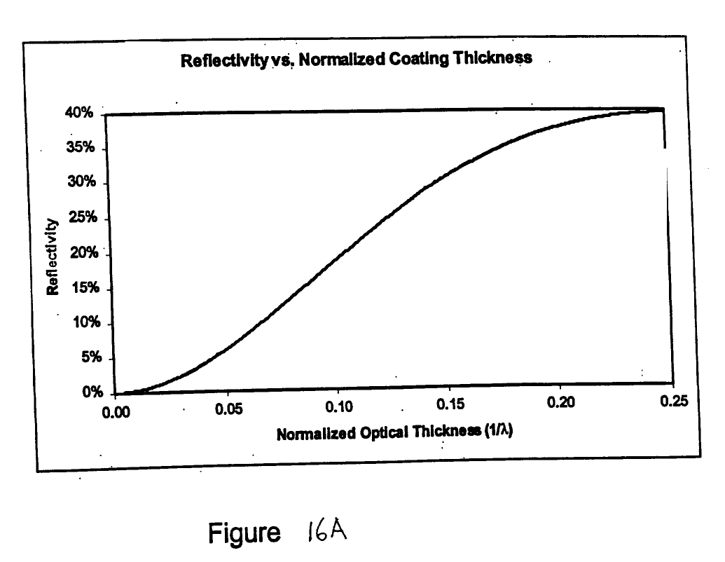

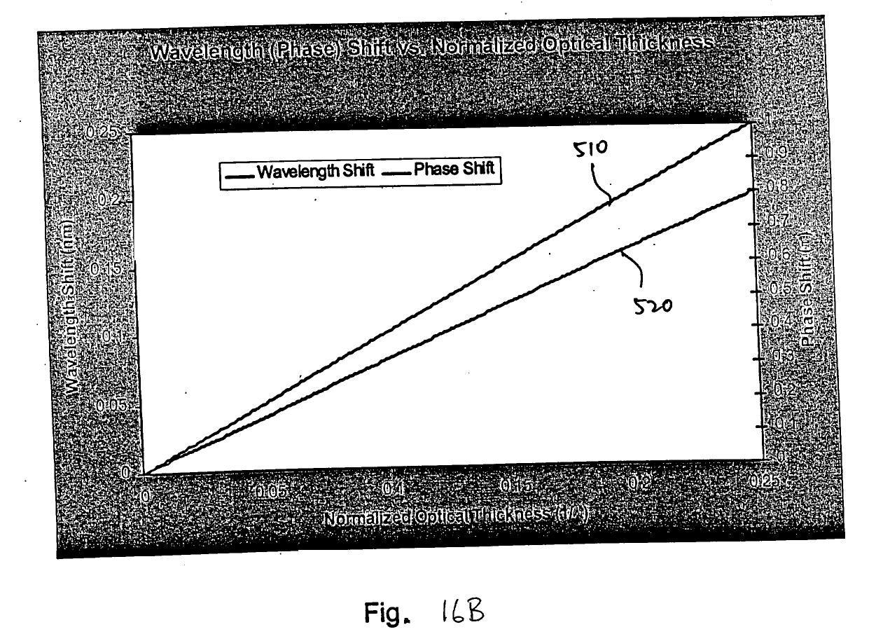

FIGS. 16A-16B are graphs further illustrating the performance of variable reflectivity etalon 100. FIGS. 16A and 16B detail the performance of a 3-layer structure where the top layer 310 which varies in thickness from zero to a quarter wave. However, the general

phenomenon illustrated by FIGS. 16A and 16B are also applicable to reflective coatings with other numbers of layers. FIG. 16A graphs reflectivity R as a function of thickness of top layer 310. The thickness is typically measured in reference to optical wavelength. Thus, a normalized optical thickness of 0.10 corresponds to a physical thickness that results in 0.10 wavelength. The normalized optical thickness of 0.00 corresponds to zero thickness and the normalized optical thickness of 0.25 corresponds to a quarter wave thickness. The reflectivity varies from 0%-40%. As mentioned previously, the range of reflectivities can be offset and/or expanded by adding more layers 320.

Referring again to the examples in FIGS. 14-15, these examples vary reflectivity by varying the optical thickness of the front reflective coating 120. However, varying the optical thickness also varies the phase of the OPL. This variation is not significant enough to substantially change the free spectral range of the etalon, so the basic periodicity of the etalon response essentially remains fixed. However, this phase variation is significant enough to affect the location of the peak of the etalon response. In other words, referring to FIGS. 10, the curves 210, 220 and 230 will shift slightly to the right or left with respect to each other as a result of the phase shift introduced by the finite thickness of front reflective coating 120.

FIG. 16B graphs this effect. Curve 510 graphs the phase shift in OPL as a function of the layer thickness, which is normalized in wavelength. Curve 520 graphs the corresponding wavelength shift of the spectral response as a function of the layer thickness, assuming a free spectral range of 50 GHz. For example, at a thickness of a quarter wave, the single layer coating introduces a phase shift of π radians, which shifts the spectral response by 0.2 nm relative to the response at zero thickness.

In some cases, it is undesirable to have a phase shift (and corresponding shift of the spectral response). For example, it may be desirable for all of the spectral responses to have peaks and minima at the same wavelengths, as shown in FIGS. 10A and 10B. In these cases, the phase shift caused by thickness variations in the front reflective coating 120 must be compensated for. In one approach, the transparent body 110 has an optical path length which varies with location, and the variation in the transparent body 110 compensates for the variation caused by the front reflective coating 120.

Referring to FIG. 14A, in one example embodiment, the front and back surfaces 112 and 114 of transparent body 110 are not exactly parallel. Rather, they are slightly tilted so that the body 110 is thicker at point 155B than at 155A, thus compensating for the thinner top layer 310 at point 155B.

In FIG. 17, the transparent body 110 has a constant physical thickness but varying refractive index, thus compensating for phase variations caused by the front reflective coating 120. More specifically, the body 110 includes a gradient index material 111 bonded to a constant index material 113. In the 1.55 μm example described above, Gradium™, (available from LightPath Technology) or liquid crystal is suitable as the gradient index material 111 and fused silica, BK7 or similar glass can be used as the constant index material 113. The refractive index of the gradient index material 111 is higher at point 155B than at 155A. As a result, the optical path length through material 111 is longer at point 155B, thus compensating for the thinner front reflective coating 120.

In an alternate approach, the phase is adjusted by changing the temperature of the etalon 100. Thermal expansion changes the physical dimensions of the etalon, resulting in a corresponding change in optical path lengths. Thus, by changing the temperature of the etalon 100, the dispersion characteristic can also be shifted. In particular, the temperature may be controlled so that a center wavelength of the etalon's spectral response falls at some predefined wavelength.

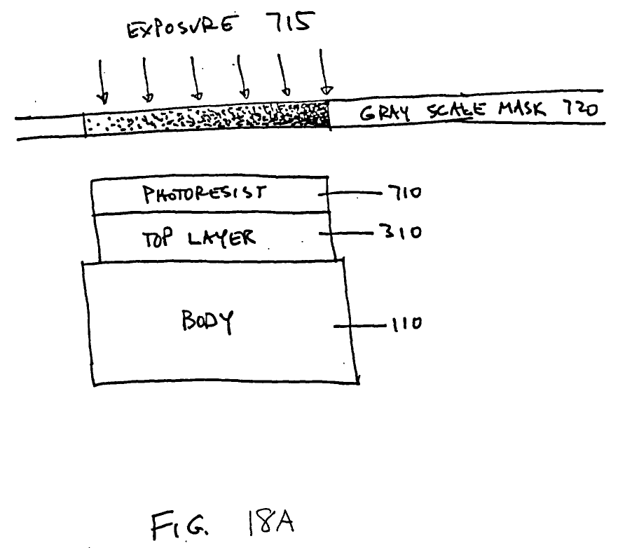

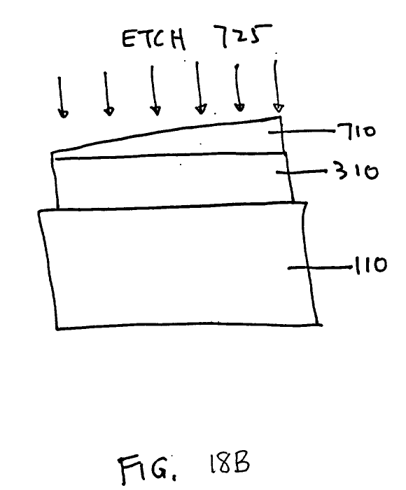

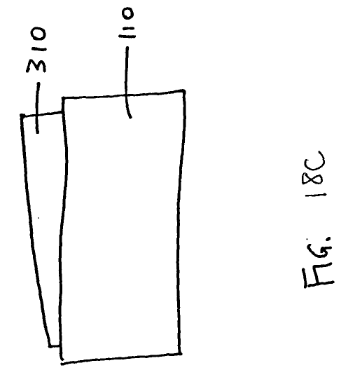

FIGS. 18A- 18C illustrate one method for manufacturing the etalon shown in FIG. 14A. Basically, a top layer 310 of uniform thickness is first deposited on the front surface 112 of the etalon body 110. Then, different thicknesses of the top layer 310 are removed according to the location on the front surface. What remains is a top layer 310 of varying thickness.

In FIG. 18A, a uniform top layer 310 has already been deposited on the etalon body 110 using conventional techniques. The top layer 310 has also been coated with photoresist 710. The photoresist 710 is exposed 715 using a gray scale mask 720. Thus, the photoresist receives a variable exposure. In FIG. 18B, the photoresist 710 has been developed. The gray scale exposure results in a photoresist layer 710 of variable thickness. The device is then exposed to a reactive ion etch (RIE). In areas where there is thick photoresist, the etch removes all of the photoresist and a little of the top layer 310 of the front reflective coating. In areas where there is thin photoresist, the etch removes more of the top layer 310. The end result, shown in FIG. 18C is a top layer of varying thickness.

FIGS. 18A-18C illustrate a manufacturing process that uses reactive ion etching although other techniques can be used. For example, in a different approach, other uniform etching techniques or ion milling can be used to remove different thicknesses from the top layer 310. Mechanical polishing techniques or laser ablation may also be used. In one laser ablation approach, a laser is scanned across the top layer 310 and ablates different amounts of material at different locations. The result is a top layer 310 of varying thickness. In a different approach, rather than depositing a top layer 310 of uniform thickness and then removing different amounts of the top layer, a top layer 310 of varying thickness is deposited. Finally, FIGS. 18A- 18C describe the manufacture of the etalon in FIG. 14A. However, the techniques described can be used to manufacture other types of variable reflectivity etalons, including those shown in FIGS. 14-17.

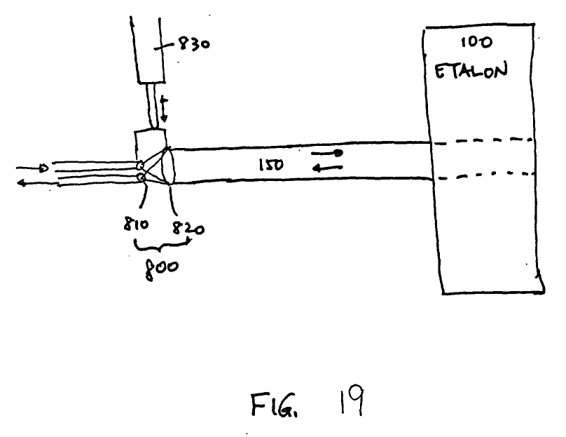

FIGS. 19-23 illustrate different ways to translate the point of incidence of the optical beam 150. In all of these examples, the input/output port 800 is depicted by two fibers 810 and a collimating lens 820, and the optical beam 150 is shown as completely overlapping in the forward and return directions. This is merely a pictorial representation. As discussed previously, various designs are possible for coupling from an input fiber and back into a separate output fiber. For clarity, the optical system 40 which achieves this functionality is not shown in FIGS. 19-23. Rather, these figures are used primarily to illustrate different approaches to translate the point of incidence of optical beam. The optical systems 40 discussed above can be straightforwardly added to the concepts shown in FIGS. 19-23 in order to complete the overall system.

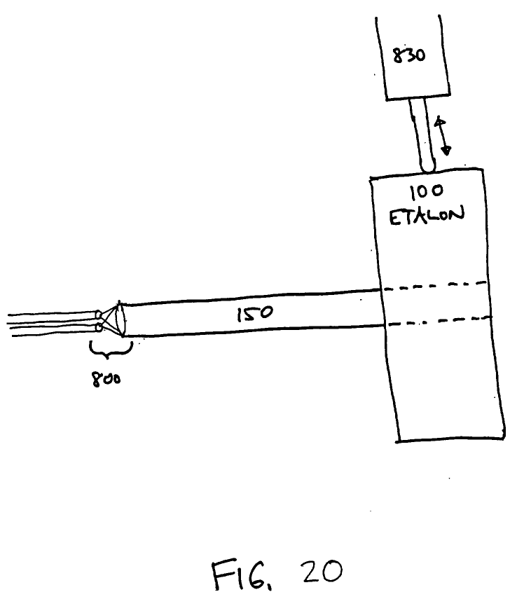

In FIGS. 19-20, beam displacement is achieved by creating relative movement between the port 800 and the variable reflectivity etalon 100. In FIG. 19, the port 800 is translated relative to a stationary variable reflectivity etalon 100. In particular, a mechanical actuator 830 moves the relevant parts of port 800, thus moving the point of incidence. More generally, an actuator which is physically connected to the port 800 can be used to translate the port 800 relative to the etalon 100, thus changing the point of incidence. In FIG. 13, a mechanical actuator 830 is connected to the etalon 100 and translates the variable reflectivity etalon 100 relative to a stationary optical beam 150. In other implementations, both the port 800 and the etalon 100 can be moved simultaneously.

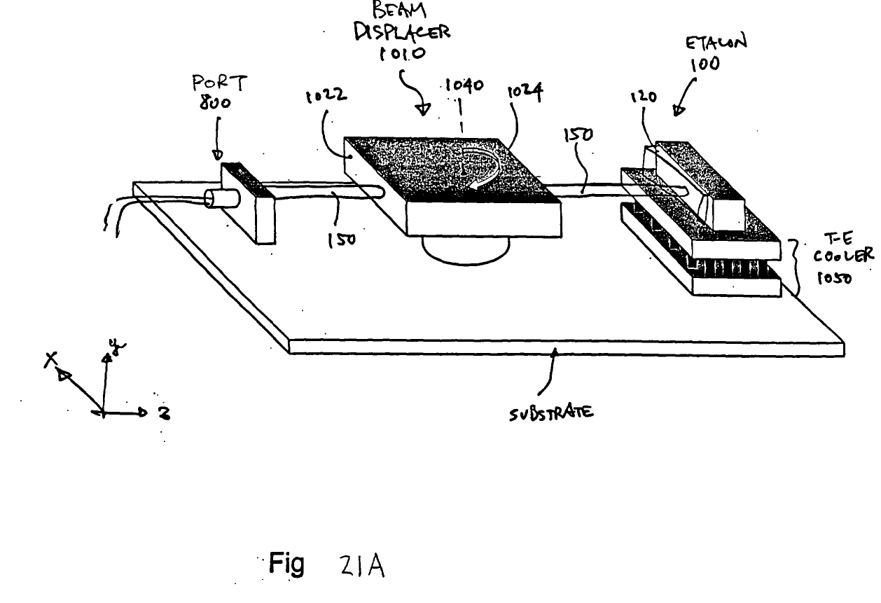

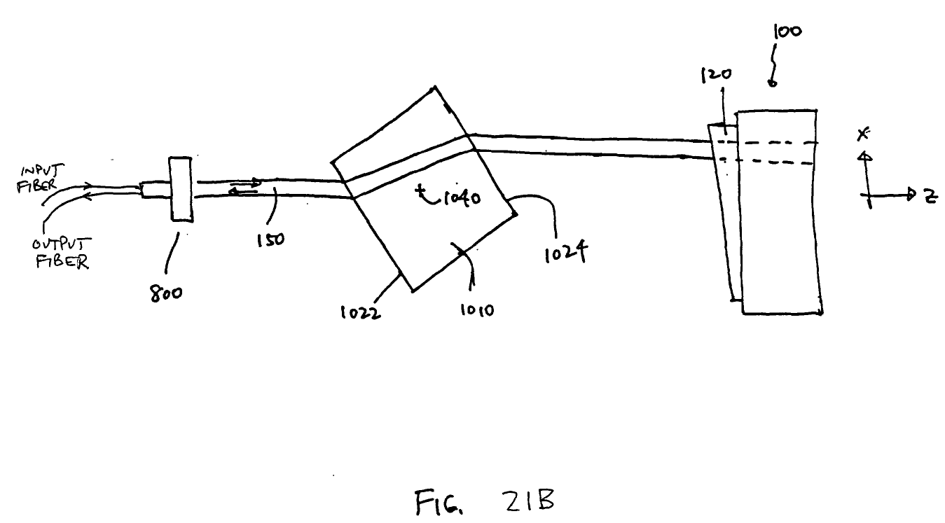

In FIGS. 21-23, the port 800 and etalon 100 remain in fixed locations relative to each other. A separate beam displacer 1010, 1110, 1210 is located in the optical path between the port 800 and etalon 100. The beam displacer is used to change the point of incidence of the optical beam 150 to different locations on the etalon's front surface while maintaining normal incidence of the optical beam on the etalon's front surface.

FIGS. 21A-2 1 B are a perspective view and a top view of an etalon stage in which the beam displacer 1010 is rotated in order to change the point of incidence. In this example, the beam displacer 1010 includes a transparent body 1020 that has an input surface 1022 and an output surface 1024. The beam displacer 1010 is located in the optical path of the optical beam 150 and rotates about an axis 1040 which is perpendicular to the direction of propagation of the optical beam 150. In this example, the input and output surfaces 1022 and 1024 are plane-parallel to each other. In FIGS. 21, the optical beam 150 propagates in the z direction, the reflectivity of etalon 100 varies in the x direction, and the axis of rotation 1040 is in the y direction.

The beam displacer 1010 operates as follows. The optical beam 150 enters the transparent body 1020 through the input surface 1022 and exits the body 1020 through the output surface 1024. Since the two surfaces 1022 and 1024 are parallel to each other, the exiting beam propagates in the same direction as the incoming beam, regardless of the rotation of the beam displacer 1010. As a result, the exiting beam always propagates in the z direction and the etalon 100 is oriented so that the beam 150 is normally incident upon it. Rotation of the beam displacer 1010 about they axis produces a translation of the optical beam in the x direction due to refraction at the two surfaces 1022 and 1024. The reflectivity of the front reflective coating 120 also varies in the x direction. Thus, different reflectivities for etalon 100 can be realized by rotating the beam displacer 1010.

FIG. 21 also shows the etalon 100 as being mounted on a thermoelectric cooler 1050. The cooler 1050 is in thermal contact with the transparent body of the etalon 100 and is used to control the temperature of the etalon since the temperature affects the free spectral range and OPL tuning factor of the etalon. Other types of temperature controllers may be used in place of the thermoelectric cooler 1050.

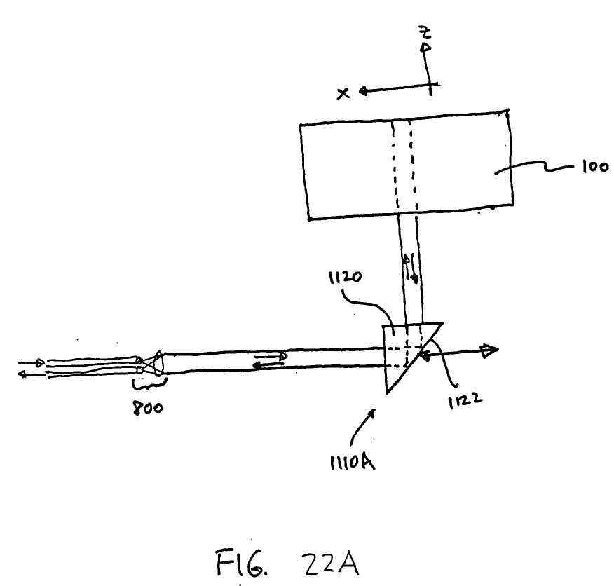

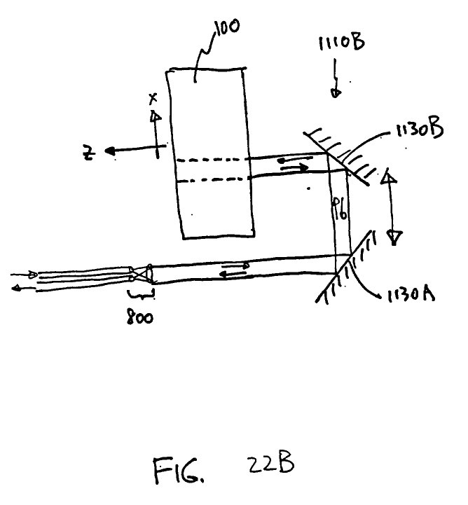

In FIGS. 22A-22B, the beam displacers 1110A and 1110B are based on translatable reflective surfaces. Generally speaking, the optical beam 150 reflects off of at least one reflective surface en route to the etalon 100. By translating the reflective surface, the point of incidence for the optical beam 150 is moved but the normal incidence is maintained. In FIG. 22A, the beam displacer 1110A includes a right angle prism 1120 and the reflective surface is the hypotenuse 1122 of the prism. The optical beam 150 enters the prism, total internally reflects off the hypotenuse 1122 and exits the prism to the etalon 100. By translating the prism 1120, the point of incidence on the etalon can be moved. Note that the prism can be translated in many directions. For example, translating in either the x or z direction will result in movement of the point of incidence.

In FIG. 22B, the beam displacer 1110B includes a pair of mirrors 1130A-B. At each mirror 1130, the optical beam 150 reflects at aright angle. Translating the mirrors 1130 in the x direction moves the point of incidence.

The beam displacers shown in FIGS. 22 are merely examples. In both of these cases, mirrors and prisms (or other types of reflective surfaces) can be substituted for each other. Furthermore, it is not necessary that the reflections occur at right angles or that the prism be a right angle prism. Other geometries can be utilized.

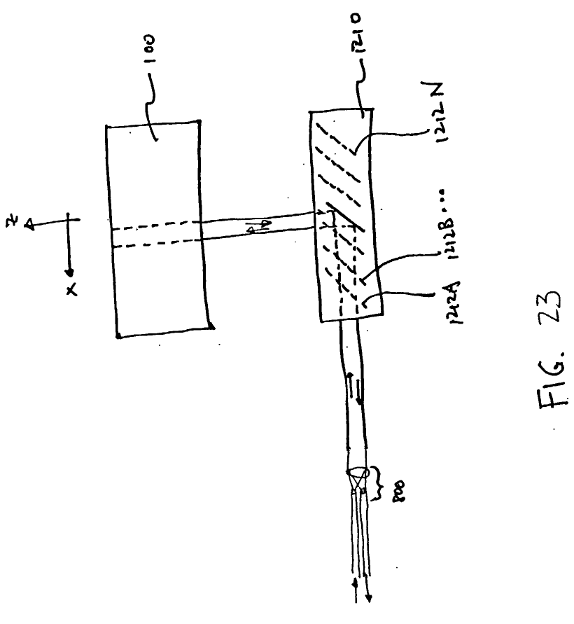

In FIG. 23, the beam displacer 1210 is a MEMS mirror. In this example, the beam displacer 1210 has a number of mirrors that can be turned on and off electrically. By turning on different mirrors, the optical beam 150 is deflected to different points of incidence. More generally, the device has a number of states, each of which directs the optical beam 150 to a different location on the etalon's front surface. Other technologies, including acousto-optics and electro-optics, can also be used.

As an example of how the optical systems 40 of FIGS. 2-7 may be combined with the beam translation systems shown in FIGS. 19-23, consider the combination of the wedge-based system in FIG. 3 and the rotating beam displacer of FIG. 21. Referring to FIG. 21, in one approach, the port 800 is implemented as a dual fiber collimator (with built-in collimating lens) and the wedges are placed in the optical path between the port 800 and the beam displacer 1010. The wedges have power in the x direction, which is consistent with the two fibers shown as separated in the x direction in FIG. 21. In a different approach, the wedges could be placed between the beam displacer 1010 and the etalon 100, but this is generally more complex since the optical path in this region can be moved in the x direction.

In an alternate approach, the wedges have power in the y direction, in which case the dual fiber collimator is rotated 90 degrees from the position shown in FIG. 21. In other words, the fibers and wedges produce lateral separation and bending of the central axis in they direction (i.e., in the y-z plane) but the beam displacer produces beam translation in the orthogonal x direction (i.e., in the x-z plane). Other approaches for combining the dual fibers systems of FIGS. 2-7 with the beam translation systems of FIGS. 19-23 will be apparent.

Although the invention has been described in considerable detail with reference to certain preferred embodiments thereof, other embodiments will be apparent. Therefore, the scope of the appended claims should not be limited to the description of the preferred embodiments contained herein.

What is claimed is:

1. An etalon stage comprising:
an input fiber;
an output fiber;
an etalon;
an optical system that is located between the fibers and the etalon, for directing light along a free space forward optical path from the input fiber to the etalon and along a free space return optical path from the etalon to the output fiber.

2. The etalon stage of claim 1 wherein a median plane is located generally midway between the fibers and is generally perpendicular to a plane defined by the fibers and the optical paths, the optical paths are characterized by a central axis, the central axis enters and exits the etalon at a substantially normal angle, and the central axis crosses the median plane at least once and bends towards the median plane at least once within each optical path.

3. The etalon stage of claim 1 wherein the optical system comprises:
a collimating lens for collimating light exiting the input fiber and for coupling collimated light into the output fiber; and
optics located between the collimating lens and the etalon;
wherein:
a median plane is located generally midway between the fibers and is generally perpendicular to a plane defined by the fibers and the optical paths, the optical paths are characterized by a central axis, and the central axis enters and exits the etalon at a substantially normal angle;
along the forward optical path, the collimating lens bends the central axis towards the median plane, the central axis crosses the median plane between the collimating lens and the optics, and the optics bends the central axis towards the median plane;
the central axis crosses the median plane at the etalon; and
along the return optical path, the optics bends the central axis towards the median plane, the central axis crosses the median plane between the optics and the collimating lens, and the collimating lens bends the central axis towards the median plane.

4. The etalon stage of claim 3 wherein the return optical path is a reciprocal mirror image of the forward optical path.

5. The etalon stage of claim 3 wherein, along the forward optical path, the optics reduces an angle between the central axis and the median plane.

6. The etalon stage of claim 3 wherein the optics increases a separation between the fibers and the etalon.

7. The etalon stage of claim 5 wherein the central axis enters and exits the etalon within three degrees of normal.

8. The etalon stage of claim 3 wherein, along the forward optical path, the optics comprises a wedge with base oriented towards the median plane.

9. The etalon stage of claim 3 wherein, along the forward optical path, the optics comprises a prism, the optical path making at least one internal reflection within the prism.

10. The etalon stage of claim 3 wherein, along the forward optical path, the optics comprises a mirror facing the median plane and approximately parallel to the median plane.

11. The etalon stage of claim 3 wherein, along the forward optical path, the optics comprises a transparent block of material with an entrance face, an exit face and a TIR face, wherein the TIR face faces the median plane and is approximately parallel to the median plane.

12. The etalon stage of claim 3 wherein the collimating lens comprises a GRIN lens.

13. The etalon stage of claim 3 wherein the optical paths have a minimum spot size at the etalon.

14. The etalon stage of claim 3 wherein, along the forward optical path, the optics bends the central axis towards the median plane at least N times where N is greater than or equal to two, and the central axis crosses the median plane at least N-1 times.

15. The etalon stage of claim 3 wherein the input fiber, the output fiber and the collimating lens are packaged as a dual fiber collimator.

16. The etalon stage of claim 1 wherein a median plane is located generally midway between the fibers and is generally perpendicular to a plane defined by the fibers and the optical paths, the optical paths are characterized by a central axis, the central axis enters and exits the etalon at a substantially normal angle, and the central axis does not cross the median plane between the fibers and the etalon.

17. The etalon stage of claim I wherein the optical system comprises:
a forward collimating lens for collimating light exiting the input fiber;
a return collimating lens for coupling collimated light into the output fiber; and
optics located between the collimating lenses and the etalon; and
wherein a median plane is located generally midway between the fibers and is generally perpendicular to a plane defined by the fibers and the optical paths, the optical paths are characterized by a central axis, the central axis enters and exits the etalon at a substantially normal angle, and the central axis does not cross the median plane between the fibers and the etalon.

18. The etalon stage of claim 17 wherein the return optical path is a reciprocal mirror image of the forward optical path.

19. The etalon stage of claim 17 wherein, along the forward optical path, the optics reduces an angle between the central axis and the median plane.

20. The etalon stage of claim 19 wherein the central axis enters and exits the etalon within three degrees of normal.

21. The etalon stage of claim 17 wherein the input fiber and forward collimating lens are packaged as a single fiber collimator; and the output fiber and return collimating lens are packaged as a separate fiber collimator.

22. The etalon stage of claim I wherein the etalon comprises a variable reflectivity etalon comprising:
a transparent body having a first surface and a second surface that is substantially plane-parallel to the first surface;
a second dielectric reflective coating disposed upon the second surface; and
a first dielectric reflective coating disposed upon the first surface, the first reflective coating having a reflectivity that varies according to location on the first surface.

23. The etalon stage of claim 22 wherein the first reflective coating of the etalon comprises:
a top layer having a physical thickness that varies according to location on the first surface and a refractive index that does not vary according to location on the first surface.

24. The etalon stage of claim 23 wherein the top layer is selected from a group consisting of Ta₂O_{5, TiO}₂, SiO₂, SiO, Pr₂O₃, Y₂O₃, and HfO₂.

25. The etalon stage of claim 22 wherein:
the optical path through the etalon is characterized by a spot size;
each location on the etalon's first surface is characterized by a dispersion curve that depends on the reflectivity of the first reflective coating at that location; and
the dispersion curve is substantially invariant over the spot size.

26. The etalon stage of claim 22 wherein:
the etalon is suitable for use in an application with a predefined periodic spacing of wavelength bands;
the etalon is characterized by a free spectral range; and
the free spectral range of the etalon is approximately equal to the predefined periodic spacing of the wavelength bands.

27. The etalon stage of claim 1 wherein the etalon comprises a compound etalon.

28. An etalon apparatus comprising:
an input fiber;
an output fiber;
a variable reflectivity etalon comprising:
a transparent body having a first surface and a second surface that is substantially plane-parallel to the first surface;
a second dielectric reflective coating disposed upon the second surface; and
a first dielectric reflective coating disposed upon the first surface, the first reflective coating having a reflectivity that varies according to location on the first surface; and
an optical system that is optically located between the fibers and the etalon, for directing light along a free space forward optical path from the input fiber to the etalon and along a free space return optical path from the etalon to the output fiber, wherein the optical paths are characterized by a central axis, the central axis enters and exits the etalon at a substantially normal angle at a point of incidence that is tunable.

29. The etalon apparatus of claim 28 further comprising:
a temperature controller coupled to the etalon for controlling a temperature of the etalon, wherein the temperature controller adjusts the temperature of the etalon to a point where a center wavelength of a spectral response of the etalon equals a predefined wavelength.

30. The etalon apparatus of claim 28 further comprising:
a beam displacer located between the fibers and the etalon, wherein the beam displacer translates the point of incidence to different locations on the etalon's first surface while maintaining substantially normal incidence of the central axis on the etalon's first surface.

31. The etalon apparatus of claim 30 wherein the beam displacer comprises:
a second transparent body having an input surface and an output surface, wherein:
the forward optical path enters the second transparent body through the input surface and exits the second transparent body through the output surface and directed to the etalon,
the second transparent body is rotatable about an axis perpendicular to a direction of propagation for the forward optical path, and
rotating the second transparent body about the axis translates the point of incidence to different locations on the etalon's first surface.
